(19) United States
(12) Patent Application Publication
(10) Pub. No.: US 2006/0224447 A1
(43) Pub. Date: Oct. 5, 2006

(54) Automated offer management using audience segment information

(76) Inventor: Ross Koningstein, Menlo Park, CA (US)

Correspondence Address: STRAUB & POKOTYLO, 620 TINTON AVENUE, BLDG. B, 2ND FLOOR, TINTON FALLS, NJ, 07724, US

(21) Appl. No.: 11/096,283

(22) Filed: Mar. 31, 2005

(51) Int. Cl. G06Q 30/00; G06F 17/00

(52) U.S. Cl. 705/14; 705/400

(57) ABSTRACT

An advertiser's management of an advertising campaign may be assisted by (a) accepting information defining a plurality of audience segments to which an advertisement may be served, (b) accepting a first offer, and (c) determining, using the first offer, a second offer associated with at least one of the plurality of audience segments. The act of determining a second offer associated with one of the plurality of audience segments may use an indication of value assigned to the one audience segment. The indication of value may be automatically determined, and/or provided by an advertiser. The indication of value may be expressed as functions, rules, and/or parameter values. The information defining a plurality of audience segments may be one or more of (a) location information, (b) user information, (c) temporal information, and (d) client device information.

### § 1. BACKGROUND OF THE INVENTION

§ 1.1 Field of the Invention

The present invention concerns advertising. In particular, the present invention concerns improving advertising by automating offer management in a way that reflects the value of different audience segments to different advertisers.

§ 1.2 Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords advertising system by Google of Mountain View, Calif., delivers ads targeted to keywords from search queries. Similarly, content targeted ad delivery systems have been proposed. For example, U.S. patent application Ser. Nos. 10/314,427 (incorporated herein by reference and referred to as “the '427 application”) titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and Ser. No. 10/375,900 (incorporated by reference and referred to as “the '900 application”) titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. Content targeted ad delivery systems, such as the AdSense advertising system by Google for example, have been used to serve ads on Web pages.

As can be appreciated from the foregoing, serving ads relevant to concepts of text in a text document and/or ads relevant to keywords in a search query is useful because such ads presumably concern a current user interest. Although keyword-targeted and content-targeted ad systems have improved the usefulness of ads, and consequently their performance (e.g., in terms of click-through rate, conversion rate, etc.), there is still room for improvement.

Like other advertising leads, not all impressions or selections are worth the same. For example, in online advertising, local advertisers may value leads from certain locales or audiences (neighborhoods, cities, counties) higher than they would other more distant or less desirable locales. More specifically, consider advertisers that cross relatively open borders, for example Canada and the USA. Although an American advertiser may value a lead from Canada, it might not value such as lead as much as one from the United States (e.g., due to extra costs and/or efforts due to customs and shipping).

Some current advertising systems allow advertisers to select countries or other predefined areas for targeting the serving of their ads. However, such systems present challenges when advertisers want to value different locations within a targeted location or locations differently. U.S. Patent application Ser. No. 10/654,265 (incorporated herein by reference and referred to as “the '265 application”), titled “DETERMINING AND/OR USING LOCATION INFORMATION IN AN AD SYSTEM,” filed on Aug. 23, 2004 and listing Leslie Yeh, Sridhar Ramaswamy and Zhe Qian as inventors describes techniques for targeting the serving of ads. For example, a restaurant may want to target ads only to potential customers within a 30 minute drive. A dry cleaner may want to target ads only to potential customers in the same town, and perhaps a few neighboring towns. As yet still another example, a regional chain of drug stores may only want to target ads to potential customers living within their region. Even if such businesses have ads that are relevant to a search query or a Web page, if the end user viewing a search results Web page or the content of a Web page is outside the geographic reach of their business, the ads will not be very useful and will not perform well. The '265 application describes solutions that address these needs. However, even within a targeted location, eligible ad impressions or selections might not be of equal value to an advertiser. Unfortunately, it may be cumbersome for an advertiser to express these difference in value such that they are reflected in their ad campaign.

As another example, an all night diner might value leads in the evening (e.g., between 5 PM and 10 PM local time) more than leads in the morning or afternoon. As yet another example, an advertiser with a rich video-based advertisement might value impressions on desktop computers more than on impressions on mobile telephones or other devices that might not be able to render the ad well.

As can be appreciated from the foregoing examples, although advertisers might want to be able to generate leads in non-optimal segments, they might not be willing to pay “full price” (e.g., the amount that they are willing to pay for optimal segments) for them.

As introduced above, some advertising systems, such as the Google AdWords system for example, allow advertisers to specify various audience segments such as country, dates, etc., for purposes of targeting. However, managing different offers (e.g., bids) for different audience segments can be challenging.

Unfortunately, online advertising systems do not support the ability to easily designate differing offer values for different market segments (e.g., different geographic areas, different times, different user devices, different audience demographics, etc., referred to collectively as different “audience segments”). Thus, advertisers may pay too much for sub-optimal leads, or may undertake significant extra work to run distinct advertising campaigns (and bids) for different audience segments. Accordingly, it would be useful to simplify the management of offers for targeted, but non-optimal, audience segments.

### § 2. SUMMARY OF THE INVENTION

At least one embodiment consistent with the present invention helps an advertiser to manage an advertising campaign by (a) accepting information defining a plurality of audience segments to which an advertisement may be served, (b) accepting a first offer, and (c) determining, using the first offer, a second offer associated with at least one of the plurality of audience segments.

The act of determining a second offer associated with one of the plurality of audience segments may use an indication of value assigned to the one audience segment. The indication of value may be automatically determined, and/or provided by an advertiser. The indication of value may be expressed as functions, rules, and/or parameter values.

At least one alternative embodiment consistent with the present invention helps advertisers manage advertising campaigns by (a) accepting information defining a plurality of audience segments to which an advertisement may be served, and (b) determining, for each of the plurality of audience segments, a relative value of the audience segment to an advertiser.

In at least some embodiments consistent with the present invention, the information defining a plurality of audience segments is one or more of (a) location information, (b) user information, (c) temporal information, and (d) client device information.

### § 3. BRIEF DESCRIPTION OF THE DRAWINGS

FIG. 1 is a high-level diagram showing parties or entities that can interact with an advertising system.

FIG. 2 is a diagram illustrating an environment in which, or with which, embodiments consistent with the present invention may operate.

FIG. 3 is a bubble diagram illustrating various operations that may be performed, and various information that may be used and/or generated, by embodiments consistent with the present invention.

FIG. 4 illustrates exemplary ad information that is consistent with the present invention.

FIG. 5 is a flow diagram of an exemplary method for automatically generating different offers (e.g., bids) for different audience segments in a manner consistent with the present invention.

FIG. 6 is a flow diagram of an exemplary method for performing audience segment selection operations in a manner consistent with the present invention.

FIG. 7 is a flow diagram of an exemplary method for performing automatic offer adjustment operations in a manner consistent with the present invention.

FIG. 8 is a flow diagram of an exemplary method of performing user behavior feedback operations in a manner consistent with the present invention.

FIG. 9 is a block diagram of an exemplary apparatus that may perform various operations and store various information in a manner consistent with the present invention.

### § 4. DETAILED DESCRIPTION

The present invention may involve novel methods, apparatus, message formats, and/or data structures for obtaining audience segment information in an ad serving system, and/or using such audience segment information for automating offer management. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

In the following, definitions of terms that may be used in this specification are provided in § 4.1. Then, environments in which, or with which, embodiments consistent with the present invention may operate are described in § 4.2. Thereafter, exemplary embodiments consistent with the present invention are described in § 4.3. Examples of operations illustrating the utility of exemplary embodiments consistent with invention are described in § 4.4. Finally, some conclusions regarding the present invention are set forth in § 4.5.

§ 4.1 Definitions

Online ads may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the present invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document being served includes certain topics or concepts, or falls under a particular cluster or clusters, or some other classification or classifications. In some systems, an advertiser may specify that its ad is to be served only to (or is not to be served to) user devices having certain characteristics. Finally, in some systems an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) is referred to as the “conversion rate.” If a conversion is defined to be able to occur within a predetermined time since the serving of an ad, one possible definition of the conversion rate might only consider ads that have been served more than the predetermined time in the past.

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a Realnetworks streaming audio file player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary. A “Web publisher” is an example of a content owner.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

“Geolocation information” may include information specifying one or more of one or more countries, one or more (inter-country) regions, one or more states, one or more metro areas, one or more cities, one or more towns, one or more boroughs, one or more areas with common zip codes, one or more areas with common telephone area codes, one or more areas served by common cable head end stations, one or more areas served by common network access points or nodes, etc. It may include latitude and/or longitude, or a range thereof. It may include information, such as an IP address, from which a user location can be estimated.

An “audience segment” can be defined by one or more of when, to where, to what, and to whom an ad is being served. Thus, audience segments may be defined by one or more of location information, temporal information, user device (client device) information, and user information. Although the term “audience segment” may suggest defining groups of audiences using some discrete or quantified measure (e.g., within 0-5 mile radius, within 5-10 mile radius, outside 10 mile radius), an audience segment may be defined by continuous values (such that as the number of segments increases, the segments can be defined by a value that approaches continuity). Accordingly, “audience segments” may be used to differentiate different ad serves having different ad serve parameters (different serve times, different client device locations, different end user characteristics, different client device characteristics, etc.). As can be appreciated from the foregoing, some audience segments may be defined by rules and/or parameters (e.g., ad serves to within the United States of America versus ad serves to outside the United States of America, ad serves on weekdays versus ad serves on weekends, etc.), or by functions and/or parameters (e.g., parameter_a/(distance to client device).). As can be appreciated, some audience segments may be known ahead of time, while others (typically those defined by functions) may be determined as needed (e.g., substantially at the time of serving an ad).

An “offer” includes, but is not limited to a maximum bid (perhaps subject to discounting) per ad impression, a maximum bid per ad selection, a maximum bid per ad conversion, a bid per impression, a bid per ad selection, and a bid per ad conversion.

§ 4.2 Exemplary Advertising Enviornments in which, or with which, Embodiments Consistent with the Present Invention May Operate

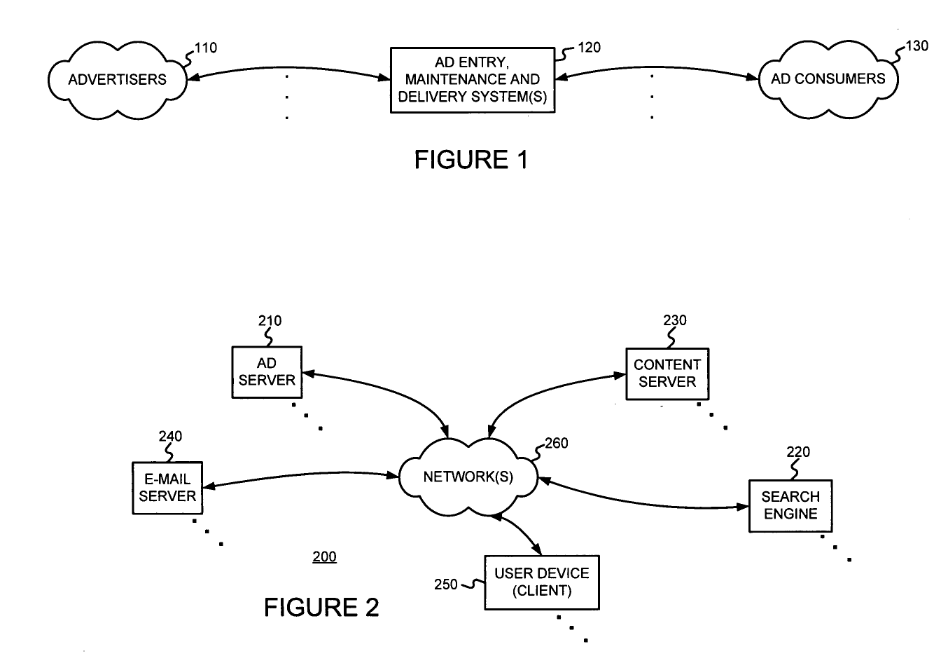

FIG. 1 is a high level diagram of an exemplary advertising environment. The environment may include an ad entry, maintenance and delivery system (simply referred to as an ad server) 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or selection related to the ad occurred) to the system 120. This usage information may include measured or observed user behavior related to ads that have been served.

The ad server 120 may be similar to the one described in FIG. 2 of the '900 application. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, etc.), and price information (e.g., maximum cost (cost per selection, cost per conversion, etc.)). Alternatively, or in addition, each ad group may include an average cost (e.g., average cost per selection, average cost per conversion, etc.). Therefore, a single maximum cost and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or service). Consistent with the present invention, the ad information may include audience segment targeting information, audience segment performance information, and audience segment price information. Naturally, the ad information may include more or less information, and may be organized in a number of different ways.

FIG. 2 illustrates an environment 200 in which the present invention may be used. A user device (also referred to as a “client” or “client device”) 250 may include a browser facility (such as the Explorer browser from Microsoft, the Opera Web Browser from Opera Software of Norway, the Navigator browser from AOL/Time Warner, the Firefox browser from Mozzila, etc.), an e-mail facility (e.g., Outlook from Microsoft), etc. A search engine 220 may permit user devices 250 to search collections of documents (e.g., Web pages). A content server 210 may permit user devices 250 to access documents. An e-mail server (such as GMail from Google, Hotmail from Microsoft Network, Yahoo Mail, etc.) 240 may be used to provide e-mail functionality to user devices 250. An ad server 210 may be used to serve ads to user devices 250. The ads may be served in association with search results provided by the search engine 220. However, content-relevant ads may be served in association with content provided by the content server 230, and/or e-mail supported by the e-mail server 240 and/or user device e-mail facilities.

As discussed in the '900 application (introduced above), ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, etc. Consistent with the present invention, the request may also include geolocation information, such as location information about an end user that submitted a search query. Consistent with the present invention, the request may also include audience segment information, or information (e.g., end user information) from which an audience segment can be derived.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where (such as geolocation information) the ads are to be rendered (e.g., position, selection or not, geo-location information, audience segment information, impression time, impression date, size, conversion or not, etc.) back to the ad server 120/210. Alternatively, or in addition, such information may be provided back to the ad server 120/210 by some other means. Consistent with the present invention, the ad server 120/210 may store ad performance information on the basis of geolocation information and/or audience segment information.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc. Consistent with the present invention, the request may also include geolocation information, such as location information about an end user that submitted a search query. Consistent with the present invention, the request may also include audience segment information, or information (e.g., end user information) from which an audience segment can be derived.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine 220 may transmit information about the ad and when, where (e.g., geolocation), and/or how the ad was to be rendered (e.g., position, click-through or not, impression time, impression date, size, conversion or not, geolocation information, audience segment information, etc.) back to the ad server 120/210. Alternatively, or in addition, such information may be provided back to the ad server 120/210 by some other means. Consistent with the present invention, the ad server 120/210 may store ad performance information on the basis of geolocation information and/or audience segment information.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under over, or otherwise in association with an e-mail.

Although the foregoing examples described servers as (i) requesting ads, and (ii) combining them with content, one or both of these operations may be performed by a client device (such as an end user computer for example).

§ 4.3 Exemplary Embodiments

Different audience segments may be defined using one or more of location information, temporal information, user device information, and user information. Different value indicators may be associated with different audience segments. The value indicators may be expressed as rules, parameters, and/or functions. The value indicators may be defined by an advertiser and/or automatically determined (e.g., using per audience segment ad performance information). Given a baseline offer (e.g., provided by an advertiser), an offer for a particular audience segment can be determined using the baseline offer and the value indicator associated with the audience segment. This simplifies the management of offers in an online ad campaign.

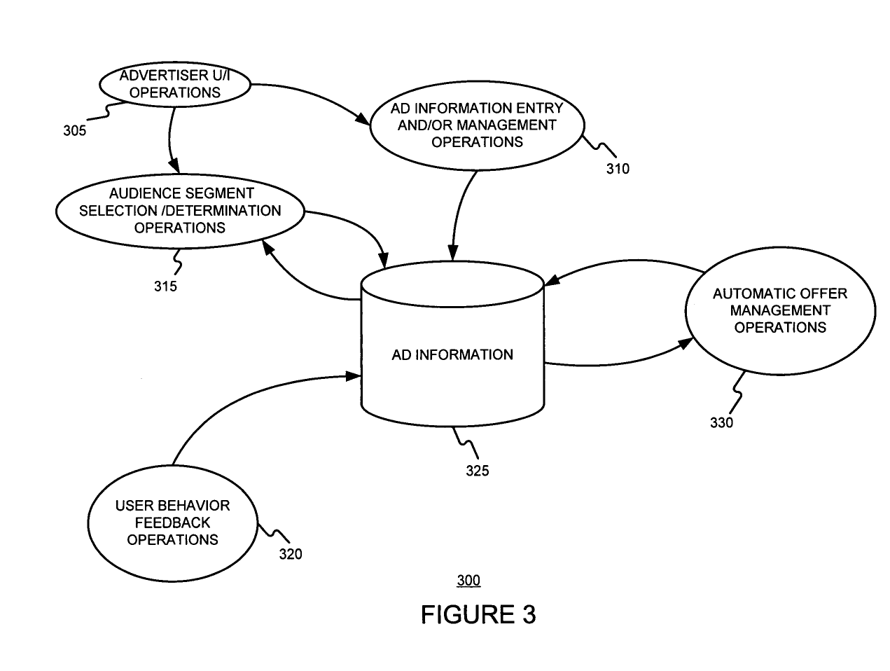

FIG. 3 is a bubble diagram illustrating various operations that may be performed in a manner consistent with the present invention, and various information that may be used and/or generated in a manner consistent with the present invention. Advertisers may use advertiser user interface operations 305 to enter and manage (e.g., update, delete, supplement, etc.) ad information in the ad information database 325 (through ad information entry and/or management operations 310). Advertisers may also use the advertiser user interface operations 305 to select audience segments to be used (e.g., for targeting and/or automated offer management) with their ad campaigns using the audience segment selection/determination operations 315.

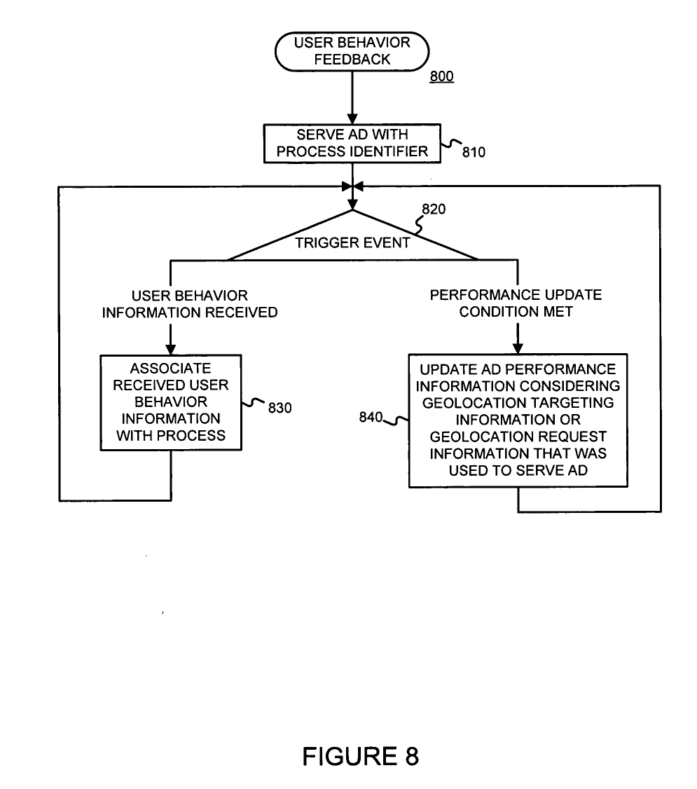

The ad information 325 may include audience segment-based performance information. Such information may be tracked, aggregated, and/or provided by user behavior feedback operations 320. (Exemplary methods that may be used to perform the user behavior feedback operations 320 are described below with reference to FIG. 8.)

The automatic offer management operations 330 can be used to determine or adjust (e.g., tier) automatically offer information using an audience segment, or segments to which the ad is to be rendered, advertiser defined or selected parameters, functions and/or rules (heuristics), etc. Such offer adjustments may be performed ahead of time, and/or as needed (e.g., at a time of ad arbitration or auction). The automatic offer management operations 330 may determine or adjust offers in accordance with pre-defined default rules, functions, and/or parameters, and/or rules, functions, and/or parameters entered and/or selected by an advertiser. For instance, an advertiser may specify an offer multiplier (which is an example of a parameter) that exponentially decreases as the distance from the end user (to which the ad is to be presented) to the location of the advertiser increases (which is an example of a function). In this example, without any intervention from the advertiser (perhaps besides initial setup), the advertising system could automatically adjust the advertiser's offers in real-time depending on the location of the end user to which the advertiser's ads are to be rendered. If the advertiser were to change its “baseline” offer (e.g., for one audience segment, such as its optimal audience segment), it would not need to separately update offers for other audience segments. As another example, an advertiser may specify an offer multiplier of 1.0 for end users within a 5 mile radius of its location, an offer multiplier of 0.7 for end users more than a 5 mile radius, but within a 10 mile radius of its location, and an offer multiplier of 0.1 for end users outside a 10 mile radius of its location, thereby defining three (3) “tiers” of audience segments, defined by distance from location, each of which will have a different associated offer.

The audience segment selection/determination operations 315 may be used by the advertiser to specify audience segments (e.g., to be used for targeting and/or adjusting offers). Such operations 315 may be used to automatically determine audience segments as suggestions which may be selected by the advertiser. For example, the advertising audience targeting selection operations 315 may provide the advertiser with a list of suggested audience segments that were determined using performance information tracked by the user behavior feedback operations 320. The advertiser may select one or more audience segments from the suggested list. Alternatively, or in addition, an audience segment can be defined manually by having the advertiser specify characteristics of audience segments to generate custom-defined audience segments on the basis of one or more of user information (e.g., languages, demographics, salary, occupation, nationality, ancestry, age, sex, etc.), user device location (e.g., zip codes, IP address, town, city state, region, country, etc.), end user device information (e.g., mobile telephone, PDA, laptop computer, personal computer, connection speed, processor speed, communications speed, display size, display resolution, etc.), temporal information (e.g., time of day, day of week, month, season, etc.), etc.

Finally, the ad information 325 may include an ad identifier, creative information, ad landing page information, targeting information, and/or price (offer) information. This information may be entered and/or modified by advertisers or their representatives via ad information entry and/or management operations 310 along with audience segment selection/determination operations 315. As can be appreciated, the price information may include a single “baseline” offer. This offer may be associated with a particular audience segment (e.g., an optimal audience segment), but it doesn't have to be. Other offers for other audience segments can be predetermined (e.g., using rules, functions, and/or parameters) and stored as ad information. Alternatively, or in addition, other offers for other audience segments can be determined (e.g., using rules, functions, and/or parameters) as needed (e.g., at the time of an arbitration that uses offers of ads).

Although targeting information may correspond to audience segments having different offers, it doesn't have to. For example, an advertiser may specify that its ad is to be targeted to the keyword “shoes” and targeted only to end user devices in the state of California, but may specify “weekday” and “weekend” audience segments, where the weekend audience segment has an offer multiplier of 1.0, and the weekday audience segment has an offer multiplier of 0.4. The ad may have a maximum offer per selection of $1.00. Suppose that a first end user in Utah submits a search query for “shoes”. In this instance, the ad would not be eligible for serving since it is targeted to end users in California. Thus, the audience segment “California user devices” is used for targeting, but not for determining offers in this example. Suppose that a second end user in California submits a search query for “shoes” on Tuesday. In this case, the ad would be eligible to be served, and a $1.00 offer (=$1.00*1.0) could be used in an arbitration and to determine a payment if the second end user selected the ad. Finally, suppose that a third end user in California submits a search query for “shoes” on Saturday. In this case, the ad would be eligible to be served, and a $0.40 (=$1.00*0.4) offer could be used in an arbitration and to determine a payment if the third end user selected the ad.

§ 4.3.1 Exemplary Data Structures

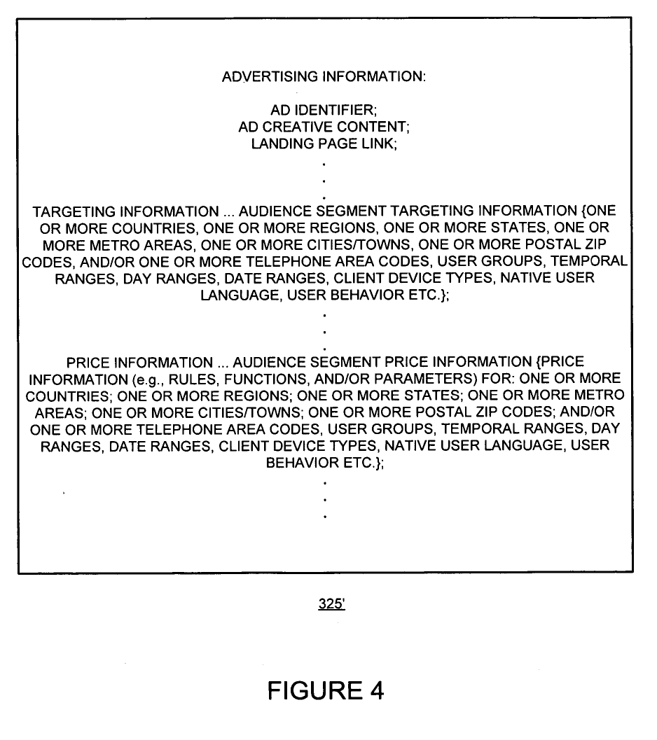

FIG. 4 illustrates exemplary ad information 325′ that is consistent with the present invention. The ad information 325′ may include information such as that described above. For example, the ad information 325′ may include a unique ad identifier, ad creative content (or a pointer to such creative content), and/or a landing page link (e.g. URL), etc. Further, the exemplary ad information 325′ may include at least one of audience segment targeting information and audience segment price information. Audience segment performance information (not shown) may be tracked and associated with the ad.

Audience segment targeting information may include one or more of location information, temporal information, client device information, user information, etc.

The location information may be geolocation information including one or more countries, one or more regions, one or more states, one or more metro areas, one or more cities, one or more towns, one or more postal zip codes, and/or one or more telephone area codes, etc. Thus, for example, a business selling irrigation systems can target its ads to the states California, Nevada, Arizona and New Mexico, while a business selling snow blowers can target its ads to states, such as Maine and Minnesota for example, with relatively significant snowfall. A dry cleaner can target its ads to the town in which it is located, as well as neighboring towns, and/or various postal zip codes, and/or various telephone area codes. A professional sports team can target ads for tickets and/or merchandise to a metro area. A national shipping company can target its ads to a country.

The time information may include one or more of a time range, a day or day range, and a date or date range. Thus, for example, a pizzeria can target its ads to dinnertime, and Sundays during football season. A flower delivery business can target its ads to Mother's Day, Valentine's Day, and the days preceding these days.

The client device information may include one or more of whether or not the client device is portable, whether or not the client device is mobile, whether or not the client device has call functionality, whether or not the client device has messaging (e.g., instant messaging, email, etc.) functionality, whether or not the client device has a display and if so, the characteristics of the display, whether or not the client device has a speaker, characteristics of the client device communications link, whether or not the client device has sufficient processing for images, audio, video, animation, etc., etc.

The user device information may include one or more of user demographic information (e.g., age or age range, income or income range, ethnicity, marital status, sex, level of education, etc.), user behavior information (e.g., Web browsing history, past ad selections, past online purchases, etc.), native languages, etc.

Price information may include price information for each of one or more audience segments. As described below, price information for various audience segments may be determined from so-called “baseline” price information (which may be (though need not be) associated with a particular audience segment), rules, functions, and/or parameters.

§ 4.3.2 Exemplary Methods

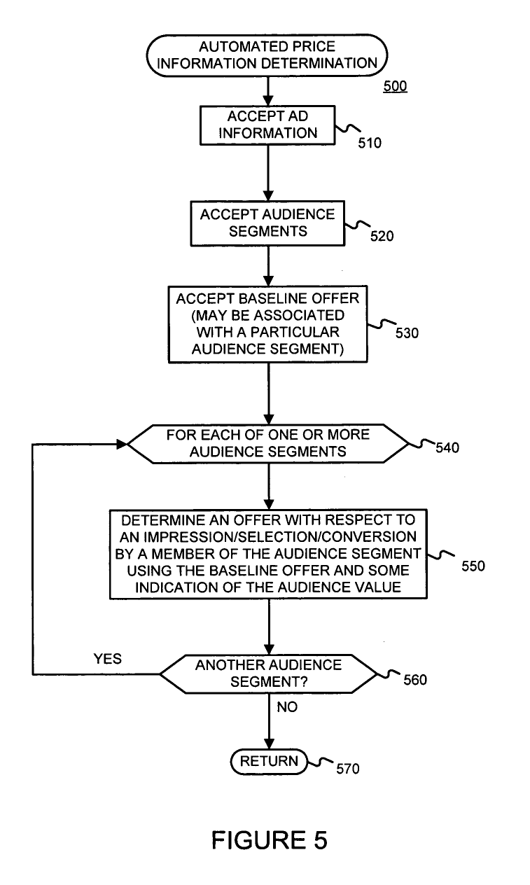

FIG. 5 is a flow diagram of an exemplary method 500 that may be used to automate price information determination using audience segment information in a manner consistent with the present invention. Ad information is accepted. (Block 510) The advertising information may include, among other things, audience segment targeting information, (e.g., per audience segment) performance information (e.g., selection rate, conversion rate, etc.), etc. Audience segments are accepted (Block 520) and a baseline offer (which may be associated with a particular audience segment) is accepted (Block 530). Then, as indicated by loop 540-560, an act is performed for each of one or more audience segments. Specifically, an offer is determined for a member of the audience set using the baseline offer and some indication of value of the audience segment. (Block 550) In this way the offer values associated with audience segments can be determined relative to the baseline offer.

Referring to block 520, recall that advertisers may have used the audience segment selection/determination operations 315 to define or select audience segments (e.g., on the basis of one or more of location information, temporal information, client device information, user information, etc.). For example, the advertiser may be provided with a suggestion list from which the advertiser can select audience segments. Alternatively, or in addition the advertiser may define or specify the audience segments. Alternatively, or in addition, the audience segments may be defined by the ad serving system (e.g., using automated algorithms, or predefined segments) without advertiser input.

Referring back to block 530, an advertiser may specify a baseline offer from which other offers may be derived by the system. For instance, an advertiser may specify different offers, for each targeting keyword/concept. Hence, the advertiser may choose to use a baseline measure of the value of selections, such as the value of selections coming from users within a favorite geographical location, to determine a baseline offer. Thus, a baseline offer may be (though need not be) associated with a particular audience segment.

Referring to block 550, the method 500 may use audience segment information and baseline offer information (Recall, e.g., Blocks 520 and 530.) to determine offers for each of at least one audience segment. The advertiser may specify how offers are to be determined from the baseline offer for each audience segment. For example, perhaps after understanding the behavior of various audience segments (e.g., as tracked by the user behavior feedback operations 320), the advertiser may enter and/or select rules, functions, and/or parameters on how the system may determine or adjust offers of ads according to the audience segment. Once the advertiser provides or selects such rules, functions, and/or parameters, the system may automatically determine offer values for the audience segments accordingly.

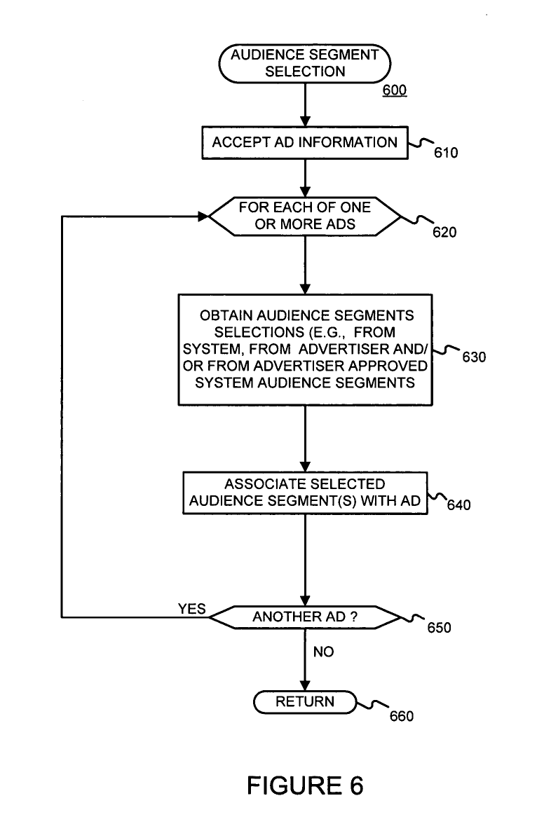

FIG. 6 is a flow diagram of an exemplary method 600 that may be used to perform audience segment selection operations in a manner consistent with the present invention. (Recall, e.g., operations 315 of FIG. 3.) Ad information may be accepted. (Block 610) The ad information may include, among other things, (e.g., audience segment specific) performance information. As indicated by loop 620-650, acts may be performed for each of one or more ads. More specifically, audience segment selections may be obtained (e.g., from an ad serving system, the advertiser, and/or advertiser approved system selections) (Block 630), and the selected audience segments are associated with the ad (Block 640).

Referring back to block 630, a suggested list of audiences may be automatically generated. For example, this may be done analyzing data from user behavior feedback operations 320 and determining how the ad (or ads) performs when served to different audience segments. In some embodiments consistent with the present invention, the advertiser might have to select audience segments from this suggestion list. In some embodiments consistent with the present invention, advertiser input (other than specifying a baseline bid and perhaps an optimal audience segment) might not be necessary. In still other embodiments, the advertiser may itself define an audience by specifying location, temporal, user device, and/or user parameters. As can be understood from the foregoing, in at least some embodiments consistent with the present invention, the advertiser may select and/or define the audience segments of their choice. Advertisers may later change, delete, or fine tune such segments (e.g., depending on ad performance when served to the various segments).

Still referring to block 630, the audience segments may be (a) defined by the system (perhaps subject to advertiser approval), or (b) specified by the advertiser. In the former case, the system may use performance information to define audience segments (e.g., by determining points at which ad performance changes, transitions). For example, if the conversion rate for an ad drops drastically for users outside of the state of California, the system may define the audience segments as (i) in California and (ii) outside of California. The number of audience segments may be determined on a case-by-case basis (e.g., based on the number of appreciable transitions in performance), may be a predetermined number (e.g., between 2 and 4, and preferably 3), or may be provided by the advertiser.

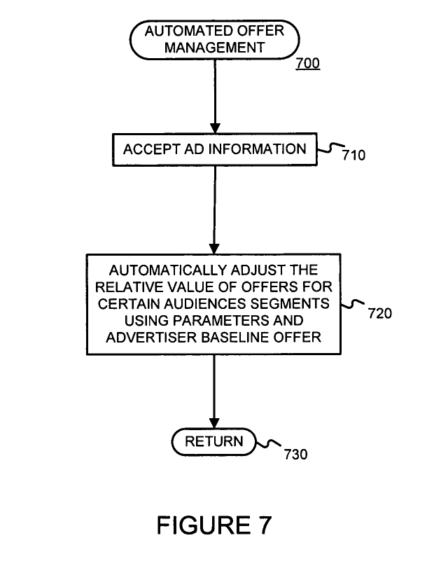

FIG. 7 is a flow diagram of an exemplary method 700 for performing automated offer management operations in a manner consistent with the present invention. (Recall, e.g., Block 550 of FIG. 5.) Ad information (e.g., a baseline offer and indicator of audience segment value) is accepted. (Block 710) The method 700 may then automatically determine offers for certain audience segments using the advertiser provided baseline offer and the indicator of audience segment value (e.g., rules, functions, and/or parameters automatically generated and/or provided by the advertiser) (Block 720) before the method 700 is left (Node 730).

As discussed earlier, the advertiser may choose a baseline offer (e.g., associated with a preferred audience). The baseline offer may be the value of selections from the advertiser's favored audience segment (e.g., favored geographical area). The advertiser may have specified how the automated bid management method 700 is to determine or adjust (e.g., tier) offers for various audience segments by (A) providing parameters (e.g., multiplication factors) for each of a number of audience segments, (B) by providing or selecting a function, which may include parameters (e.g., offer=baseline offer*1/distanceⁿ, where n is a parameter; or offer=offer*MAX [1, 0.80+selection rate_{audience segment}]), (C) rules, etc.

Comparing the performance of ads in the various audience segments, advertisers can learn the relative values of the audience segments. For example, if the offer is per ad impression, the advertiser might want to know the selection rate or conversion rate of the ad in each of various audience segments. As another example, if the offer is per ad selection, the advertiser might want to know the conversion rate of the ad in each of various audience segments.

As can be appreciated from the foregoing, since the advertiser can specify how the offers are to be determined or adjusted, the automated bid management method 700 may automatically determine or adjust offers for various audience segments in an ad campaign (e.g., in real-time depending on the audience to which the ads are being shown) without any further intervention of the advertiser. Moreover, if the advertiser adjusts its baseline offer, the method 700 may automatically adjust offers for one or more audience segments. Examples of such operations will be described in § 4.4 below.

FIG. 8 is a flow diagram of an exemplary method 800 that may be used to perform user behavior feedback operations (Recall, e.g., 320 of FIG. 3.) in a manner consistent with the present invention. The method 800 is one way to track ad performance information. When an ad is served, this event may be identified by a unique process identifier (e.g., an ad server IP address, a date and a time of day and/or other serving constraint information). The process identifier may be associated with any audience segment information (e.g., location information, temporal information, user device information, user information). Indeed, at least some of such audience segment information may be encoded into the process identifier. The ad may be served with its process identifier. (Block 810) As indicated by event block 820, different branches of the method 800 may be performed in response to different events. For example, if user behavior information is received, the received user behavior information (e.g., mouse-over, hover, scroll, selection, conversion, etc.) is associated with the process identifier (and therefore the audience segment information) (Block 830) before the method 800 branches back to event block 820. If a condition for updating performance information is met (e.g., the receipt of performance information, the receipt of a certain amount of performance information, a time expiration since the last update, an absolute time/date, etc.), the ad performance information is updated considering the audience segment information associated with the ad serving process (Block 840), before the method 800 branches back to event block 820.

Thus, the method 800 can be used to track ad performance information with respect to audience segments. The audience segments may be globally defined audience segments (e.g., across all advertisers, across some grouping of advertisers, across all advertisements, across some grouping of advertisements, etc.). Alternatively, or in addition, the audience segments may be defined to correspond to audience segments specified by a particular advertiser. Thus, in at least some embodiments consistent with the present invention, ad performance is tracked with respect to (predefined or advertiser-defined) audience segments.

Similarly, the performance may be tracked on the basis of an ad, an advertiser, a collection of ads (e.g., those that use the same targeting information), a collection of advertisers, etc. Various alternative ways of associating advertiser segment information with performance information are possible.

§ 4.3.3 Exemplary Apparatus

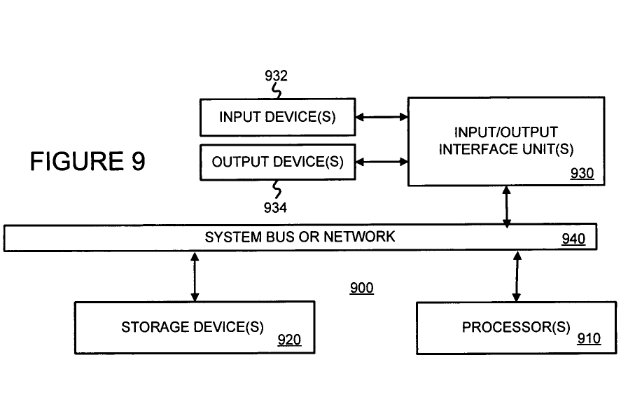

FIG. 9 is high-level block diagram of a machine 900 that may perform one or more of the operations discussed above. The machine 900 basically includes one or more processors 910, one or more input/output interface units 930, one or more storage devices 920, and one or more system buses and/or networks 940 for facilitating the communication of information among the coupled elements. One or more input devices 932 and one or more output devices 934 may be coupled with the one or more input/output interfaces 930.

The one or more processors 910 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to effect one or more aspects of the present invention. At least a portion of the machine executable instructions may be stored (temporarily or more permanently) on the one or more storage devices 920 and/or may be received from an external source via one or more input interface units 930.

In one embodiment, the machine 900 may be one or more conventional personal computers. In this case, the processing units 910 may be one or more microprocessors. The bus 940 may include a system bus. The storage devices 920 may include system memory, such as read only memory (ROM) and/or random access memory (RAM). The storage devices 920 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 932, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 910 through an appropriate interface 930 coupled to the system bus 940. The output devices 934 may include a monitor or other type of display device, which may also be connected to the system bus 940 via an appropriate interface. In addition to (or instead of) the monitor, the personal computer may include other (peripheral) output devices (not shown), such as speakers and printers for example.

Referring back to FIG. 2, one or more machines 900 may be used as end user client devices 250, content servers 230, search engines 220, email servers 240, and/or ad servers 210.

§ 4.3.4 Alternatives and Refinements

Although the automated offer manager 330 was described as determining (e.g., tiering) offers based on advertiser input, in at least some embodiments consistent with the present invention, the automatic offer manager operations 330 may adjust bids without the need to follow any rules, functions, and/or parameters set by the advertiser. For example, the automatic offer manager operations 330 may simply determine per-audience segment performance of ad campaigns (e.g., as tracked by the user behavior feedback operations 320) and use such information to associated different offers with different audience segments. The automated offer manager operations 330 may adjust the offers for certain audience segments as per-audience segment performance changes.

Although the term “audience segment” may suggest groups of audience members using some discrete or quantified measure (e.g., within 0-5 mile radius, within 5-10 mile radius, outside 10 mile radius), segment is to be interpreted to include continuous values (e.g., as the number of segments increases, the segments can approach continuity). Thus, offers may be determined or adjusted using one or more audience attributes (e.g., distance from advertiser business, time of serving, etc.) thereby enabling almost infinite audience segments.

Although some of the exemplary embodiments described above discussed “automatically” determining or adjusting offers for various audience segments, at least some embodiments consistent with the present invention may simply convey information about the (e.g., relative) value about different audience segments to advertisers. Being informed, the advertisers may then use this information to manually specify different offers for different audience segments. Thus, for example, an exemplary system consistent with the present invention may provide a message to the advertiser, such as, “Based on information we have collected, selections from users within 2 miles of your store are worth 3 times as much as selections from users beyond 2 miles but within 10 miles, and 20 times as much as selections from users beyond 10 miles.” At least some embodiments consistent with the present invention may invite advertisers to have the system adjust or determine their offer for various audience segments automatically. Thus, for example, such an exemplary system may provide a message or “button” to the advertiser, such as “Click here to adjust your keyword offers for each audience segment accordingly.”

As described above, the advertiser may have specified how the automated bid management method 700 is to determine or adjust (e.g., tier) offers for various audience segments by (A) providing parameters for each of a number of audience segments, (B) by providing or selecting a function (which may include parameters), and/or (C) by providing rules. As a first example, the advertiser might simply provide a scaling function (e.g., offer_{audience}_{_{—}}_{segment}_{_{—}}ᵢ=offer_{baseline}*factor_{audience}_{_{—}}_{segment}_{_{—}}ᵢ) and multiplication factor parameters (typically less than 1.0) for one or more audience segments to scale (e.g., reduce) a baseline offer for such audience segments. As a second example, the advertiser might provide an additive or subtractive function (e.g., ., offer_{audience}_{_{—}}_{segment}_{_{—}}ᵢ=offer_{baseline}+adjustment_factor_{audience}_{_{—}}_{segment}_{_{—}}ᵢ) and adjustment factor parameters (e.g., positive or negative) for one or more audience segments to increase or reduce a baseline offer for such audience segments. Thus, for example, an advertiser having an ad with animation may be willing to pay a premium (e.g., an extra $0.25 per impression) for the audience segment “end user device with at “good” resolution.” As a third example, an advertiser may specify a rule that certain audience segments trump others, such that the offer determinations or adjustments based on the other audience segments are weighted less or ignored. Thus, for example, an advertiser advertising Ford Mustang restoration parts may value the audience segment “user=Vintage_Ford_Mustang_Owner” so much that they will ignore the location of such a user, while if the audience segment “user=Not Vintage_Ford_Mustang_Owner,” location-based audience segments will be used to determine or adjust offers.

§ 4.4 Examples of Operations in Exemplary Embodiments

### EXAMPLE 1

The following example illustrates the utility of an exemplary embodiment consistent with the present invention. In this example consider a local advertiser who wishes to advertise its products locally for the most part.

The advertiser may enter ad information through the ad information entry and/or management operations 310, may target a relatively broad audience segment and initially provide one offer for the audience. After entering the information, the advertising system may serve the ads. Through the user behavior feedback operations 320, the advertiser may learn the relative values of impressions, selections, etc. of its ad when served to various audience segments.

For instance, local advertisers may realize that leads from an area within 30 kilometers of their location are worth more than leads from 30-60 kilometers, which in turn are worth more than leads from 60-100 kilometers, and leads beyond 100 kilometers are of no value. Accordingly, the advertiser might define or select three (3) audience segments from the audience segment targeting operations 315. The first audience segment would be end users within 30 kilometers of the location of the advertiser. This audience may also serve as the “baseline” chosen by the advertiser for its best performance and the advertiser may associate a baseline offer (e.g., a bid) for the first audience segment. Suppose the baseline offer is $2.00 per selection The other audience segments will be compared to this baseline offer. The second audience segment would include users more than 30 kilometers away, but within 60 kilometers. The third audience segment would include users more than 60 kilometers away, but within 100 kilometers. (An audience segment of within 100 kilometers may be used to target the ad, such that the ad won't even be eligible for serving if the end user device is not within 100 kilometers.)

Now that the baseline offer and audience segments have been provided, the advertiser may specify to the automatic bid management operation 330 how to determine (e.g., tier) offers for the different audience segments. The advertiser may set rules, functions, and/or parameters used by automatic bid manager to adjust the relative values of bids. For example, in this example, assume that the advertiser associates a bid multiplier of 1.00 for the first audience segment, a bid multiplier of 0.80 for the second audience segment, and a bid multiplier 0.40 for the third audience segment. Now without any advertiser intervention, the system can automatically determine (tier) offer values for its ad in real-time, depending on the audience segment to which the ad is to be served. In this case, the offer per selection for the first audience segment would be $2.00, the offer per selection for the second audience segment would be $1.60, and the offer per selection for the third audience segment would be $0.80. These offers may be used in an ad arbitration process (e.g., an auction to determine serving and position), and/or in determining an amount that the advertiser is to pay for an ad selection. If the advertiser changes its baseline offer (e.g., to $3.00), the offers for the three audience segments may be automatically updated (e.g., to $3.00, $2.40, and $1.20).

### EXAMPLE 2

The following example illustrates how various (likely independent) audience segments, and parameters associated therewith, can be combined in a manner consistent with the present invention. Supposes that truck dealer has a full screen, 600×800 pixel video ad for the Ford 350 SuperDuty pickup truck. Suppose further that one of the serving constraints is the keyword “ford” (with a baseline offer of $1.50) and another is that the end user device be within the United States of America or Canada. Since the ad may require a end user device with a full size screen and a high speed Internet connection to be rendered in an acceptable manner, the advertiser may associate a factor of 1.0 for the segment “computer with high speed connection,” 0.05 for the segment “computer with low speed connection,” and 0.00 for the segment “mobile phone” with respect to user device audience segments. Since the ad may appeal to men much more than woman, the advertiser may associate a factor of 1.0 for the segment “men” and a factor of 0.10 for the segment “women” with respect to end user audience segments. Since the advertiser may close more sales on the weekend, it may associate a factor of 1.0 for the segment “weekend” and a factor of 0.75 for the segment “weekday” for a temporal audience segment. Finally, since the advertiser may close more sales with customers within 20 miles, it may associate a factor of 1.0 for the segment “0-20 miles,” a factor of 0.70 for the segment “20-60 miles” and a factor of (0.7-(distance-60)/100) for the segment “>60 miles” for a location audience segment.

In the following scenarios, it is assumed that the user device is within the United States of America and that the user entered a search query including the term “ford.” Suppose that in a first instance, a male, 26 miles away, entered the search query “ford” on a weekday using a computer with a high speed Internet connection. The offer for the ad in this instance might be determined as $0.79 (≈$1.50*1.00*0.75*1.00*0.70). Suppose that in a second instance, a male, 2 miles away, entered the search query “ford” on a weekend using a computer with a low speed Internet connection. The offer for the ad in this instance might be determined as $0.08 (≈$1.50*1.00*1.00*1.00*0.05). Suppose that in a third instance, a female, five miles away, entered the search query “ford” on a weekday using a computer with a high speed Internet connection. The offer for the ad in this instance might be determined as $0.11 (≈$1.50*0.10*1.00*1.00*0.75). Suppose that in a fourth instance, a female entered the search query “ford”, but that not other information (e.g., location, time, user device) about the query can be determined. The offer in this instance might be determined as $0.15 (=$1.50*0.10). Note that in this last example, if audience segment information is unknown, it is ignored (i.e., the factor was assumed to be 1.00). Alternatively, a default factor for an unknown audience segment might be used. The default factor value may be a predetermined value, some average of the factors, some estimate of the probability of the a audience segment being true, etc.

As can be appreciated by the foregoing example, a factor used to determine an offer may be a composite of various factors. Although in this example, the composite was simply the product of a various factors, other functions for generating a composite factor are possible. Such composite factors allow an advertiser to avoid specifying rules, functions, and/or parameters for many narrowly defined composite audience segments. For example, 3 user device segments, 2 user segments, 2 temporal segments, and 3 location segments can be combined to define 36 (=3×2×2×3) possible composite audience segments.

Note that by simply changing its baseline offer (e.g., up to $2.00, or down to $1.35), offers for the various audience segments can be automatically adjusted or determined as needed.

§ 4.5 Conclusions

As can be appreciated from the foregoing, embodiments consistent with the present invention allow offer management to be simplified by considering audience segments (e.g., as defined by one or more of location information, temporal information, user information, client device information, etc.). Hence, offer values of ad campaigns may be automatically determined or adjusted depending on the current audience segment under consideration. This allows the advertiser to easily adjust an offer across numerous audience segments by simply changing a baseline offer. The audience segments may be predefined, automatically defined, or manually defined (e.g., by an advertiser).

What is claimed is:

1. A computer-implemented method comprising:
a) accepting information defining a plurality of audience segments to which an advertisement may be served;
b) accepting a first offer; and
c) determining, using the first offer, a second offer associated with at least one of the plurality of audience segments.

2. The computer-implemented method of claim 1 wherein the information defining a plurality of audience segments is location information.

3. The computer-implemented method of claim 1 wherein the information defining a plurality of audience segments is user information.

4. The computer-implemented method of claim 3 wherein the user information is user demographic information.

5. The computer-implemented method of claim 3 wherein the user information is user behavior information.

6. The computer-implemented method of claim 1 wherein the information defining a plurality of audience segments is temporal information.

7. The computer-implemented method of claim 6 wherein the temporal information includes one of (A) a date range, (B) a time-of-day range, and (C) a day-of-week range.

8. The computer-implemented method of claim 1 wherein the information defining a plurality of audience segments is client device information.

9. The computer-implemented method of claim 8 wherein the client device information includes whether or not the client device has call functionality.

10. The computer-implemented method of claim 8 wherein the client device information includes whether or not the client device has limited display capabilities.

11. The computer-implemented method of claim 8 wherein the client device information includes whether or not the client device has limited communications capabilities.

12. The computer-implemented method of claim 1 wherein the act of determining, using the first offer, a second offer associated with one of the plurality of audience segments uses an indication of value assigned to the one audience segment.

13. The computer-implemented method of claim 12 wherein the indication of value is assigned by an advertiser associated with the advertisement.

14. The computer-implemented method of claim 12 wherein the indication of value is determined using past performance information of the advertisement with respect to the one audience segment.

15. The computer-implemented method of claim 12 wherein the indication of value is determined using past performance information of one or more other advertisements, that are similar to the advertisement, with respect to the one audience segment.

16. The computer-implemented method of claim 15 wherein the one or more other advertisements are considered to be similar to the advertisement if they are associated with the same advertiser as is associated with the advertisement.

17. The computer-implemented method of claim 15 wherein the one or more other advertisements are considered to be similar to the advertisement if they include at least one common serving constraint as the advertisement.

18. The computer-implemented method of claim 1 wherein the act of determining, using the first offer, a second offer associated with one of the plurality of audience segments uses a value function which considers at least one characteristic of the audience segments.

19. The computer-implemented method of claim 18 wherein the value function decreases with increasing distance from the advertiser.

20. The computer-implemented method of claim 18 wherein the value function outputs continuous values.

21. The computer-implemented method of claim 18 wherein the value function outputs quantized, discrete values.

22. The computer-implemented method of claim 18 wherein the value function is a scaling function and wherein each of at least some of the plurality of audience segments includes a scaling factor.

23. The computer-implemented method of claim 18 wherein the value function is an additive function and wherein each of at least some of the plurality of audience segments includes one of (A) an incrementing factor, and (B) a reduction factor.

24. The computer-implemented method of claim 1 wherein each of the offers is selected from a group consisting of (A) a maximum offer per ad selection, (B) a maximum offer per auto telephone call on ad selection, (C) a maximum offer per ad conversion, (D) maximum offer per ad impression, (E) an offer per ad selection, (F) an offer per auto telephone call on ad selection, (G) an offer per ad conversion, and (H) an offer per ad impression.

25. The computer-implemented method of claim 1 wherein the act of determining, using the first offer, the second offer associated with one of the plurality of audience segments uses a value factor associated with the one audience segment.

26. The computer-implemented method of claim 1 wherein the act of determining, using the first offer, the second offer associated with one of the plurality of audience segments uses a composite value factor determined using appropriate ones of value factors associated with each of a plurality of audience segments.

27. The computer-implemented method of claim 1 wherein the plurality of audience segments consists of from 2 to 4 audience segments.

28. The computer-implemented method of claim 27 wherein the plurality of audience segments consists of 3 audience segments.

29. A computer-implemented method comprising:
a) accepting information defining a plurality of audience segments to which an advertisement may be served; and
b) determining, for each of the plurality of audience segments, a relative value of the audience segment to an advertiser.

30. The computer-implemented method of claim 29 further comprising:
c) providing to the advertiser, the determined relative values of the audience segments.

31. The computer-implemented method of claim 30 further comprising:
d) providing to the advertiser, means for the advertiser to elect to have offers automatically determined for the audience segments using the relative values of the audience segments.

32. The computer-implemented method of claim 31 further comprising:
e) determining offers for the audience segments using the relative values of the audience segments upon advertiser election.

33. Apparatus comprising:
a) means for accepting information defining a plurality of audience segments to which an advertisement may be served;
b) means for accepting a first offer; and
c) means for determining, using the first offer, a second offer associated with at least one of the plurality of audience segments.

34. Apparatus comprising:
a) means for accepting information defining a plurality of audience segments to which an advertisement may be served; and
b) means for determining, for each of the plurality of audience segments, a relative value of the audience segment to an advertiser.
